(19) United States
(12) Patent Application Publication
(10) Pub. No.: US 2010/0192108 A1
(43) Pub. Date: Jul. 29, 2010

(54) METHOD FOR RECOGNIZING GESTURES ON LIQUID CRYSTAL DISPLAY APPARATUS WITH TOUCH INPUT FUNCTION

(75) Inventors: CHUN TING LIU, HSIN-CHU (TW); YAO JEN HSIEH, HSIN-CHU (TW); FU CHEN FAN, HSIN-CHU (TW)

Correspondence Address: WPAT, PC;INTELLECTUAL PROPERTY ATTORNEYS, 2030 MAIN STREET, SUITE 1300, IRVINE, CA, 92614, US

(73) Assignee: AU OPTRONICS CORPORATION, HSIN-CHU (TW)

(21) Appl. No.: 12/420,487

(22) Filed: Apr. 8, 2009

(30) Foreign Application Priority Data
Jan. 23, 2009 (TW) 098102754

(51) Int. Cl. G06F 3/033

(52) U.S. Cl. 715/863

(57) ABSTRACT

One aspect of the present invention discloses a method for detecting gestures on a liquid crystal display apparatus with touch input functions is disclosed, wherein the liquid crystal display apparatus includes a display region and a button region. The method comprises the steps of checking whether an object touches a first region of the liquid crystal display apparatus, checking whether the object slides into a second region of the liquid crystal display apparatus after touching the first region, and sending a gesture signal to perform a predetermined function if the object slides between the display region and button region.

### BACKGROUND OF THE INVENTION

(A) Field of the Invention

The present invention relates to a method for recognizing gestures on a liquid crystal display apparatus with touch input function, and more particularly, to a method for recognizing gestures on a liquid crystal display apparatus with touch input function by incorporating touch and slide actions to form new input functions without modifying the hardware design so as to dramatically improve the product development flexibility.

(B) Description of the Related Art

More and more advanced-function displays are being applied in current consumer electronics products. In particular, liquid crystal displays (LCDs) having a high-resolution color screen are more widely applied in various electronic devices, such as televisions, mobile phones, personal digital assistants (PDAs), digital cameras, desktop computer screens, and notebook computer screens. To facilitate portability and usage of these devices, the LCD touch panel allowing direct touch input by the user has become a growing part of the LCD market. Conventional resistor type or capacitor type LCD touch panels, which are configured by disposing additional resistors or capacitors on the panels, determine the coordinate positions of touch points by detecting the voltage variation at the touch positions.

The conventional LCD touch panels allow the user to input data by using familiar gestures such as using the tip of the pen to write on the touch panels, which is very convenient. The LCD touch panels may determine the coordinate positions of touch objects such as the pen or finger by detecting the voltage or current variation caused by the object touch, and then conduct corresponding functions. Since the electronic devices are currently developed to be smaller and thinner, the internal space is correspondingly reduced. In addition, the electronic devices are also currently developed to be multi-functional, i.e., equipped with a variety of features. To incorporate new functions into the electronic devices, the researcher generally changes the hardware design so as to generate input mechanisms for the newly added functions in the reduced space, which obviously increases the development difficulty.

### SUMMARY OF THE INVENTION

One aspect of the present invention provides a method for recognizing gestures on a liquid crystal display apparatus with touch input function by incorporating touch and slide actions to form new input functions, without modifying the hardware design so as to dramatically improve the product development flexibility.

According to this aspect of the present invention, a method for recognizing gestures on a liquid crystal display apparatus with a display region and a button region comprises the steps of checking whether an object touches the liquid crystal display apparatus, checking whether the object slides on the liquid crystal display apparatus after touching the liquid crystal display apparatus, and forming a gesture signal to perform a predetermined function if the object slides between the display region and the button region.

Another aspect of the present invention provides a method for recognizing gestures on a liquid crystal display apparatus with a display region and a button region, and the method comprises the steps of checking whether a first object touches the button region, checking whether a second object slides on the display region, and forming a gesture signal to perform a predetermined function if the second object slides on the display region when the first object touches the button region.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed might be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become apparent upon reading the following description and upon reference to the accompanying drawings in which:

FIG. 1 illustrates the operation of a liquid crystal display apparatus with touch input function according to the first embodiment of the present invention;

FIG. 2 illustrates a flowchart showing a method for recognizing gestures according to the first embodiment of the present invention;

FIG. 3 illustrates the operation of a liquid crystal display apparatus with touch input function according to the second embodiment of the present invention;

FIG. 4 illustrates a flowchart showing a method for recognizing gestures according to the second embodiment of the present invention;

FIG. 5 illustrates the operation of a liquid crystal display apparatus with touch input function according to the third embodiment of the present invention;

FIG. 6 illustrates a flowchart showing a method for recognizing gestures according to the third embodiment of the present invention;

FIG. 7 illustrates the operation of a liquid crystal display apparatus with touch input function according to the fourth embodiment of the present invention;

FIG. 8 illustrates a flowchart showing a method for recognizing gestures according to the fourth embodiment of the present invention;

FIG. 9 illustrates the operation of a liquid crystal display apparatus with touch input function according to the fifth embodiment of the present invention;

FIG. 10 illustrates a flowchart showing a method for recognizing gestures according to the fifth embodiment of the present invention;

FIG. 11 illustrates the operation of a liquid crystal display apparatus with touch input function according to the sixth embodiment of the present invention; and

FIG. 12 illustrates a flowchart showing a method for recognizing gestures according to the sixth embodiment of the present invention.

### DETAILED DESCRIPTION OF THE INVENTION

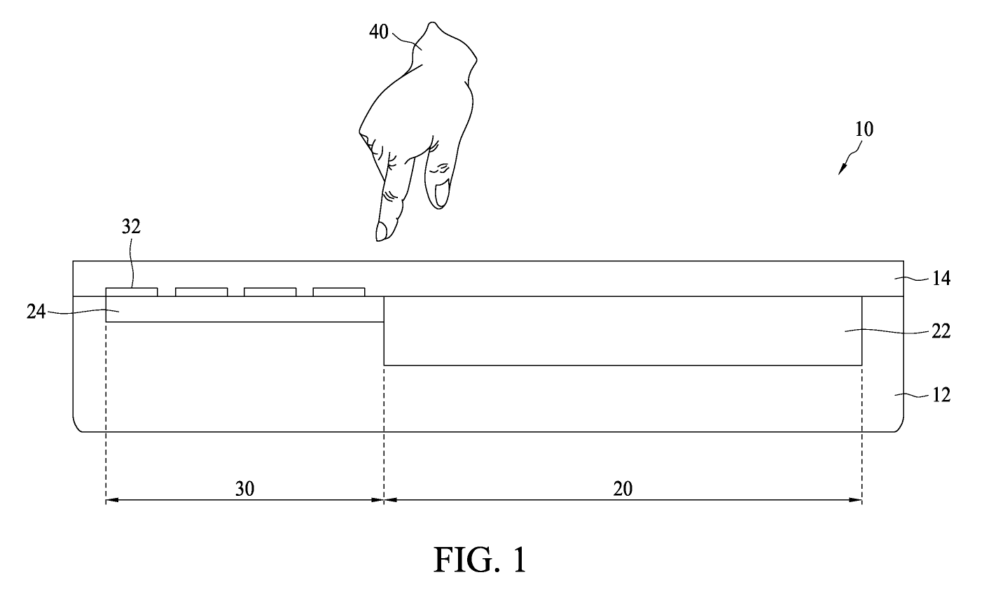

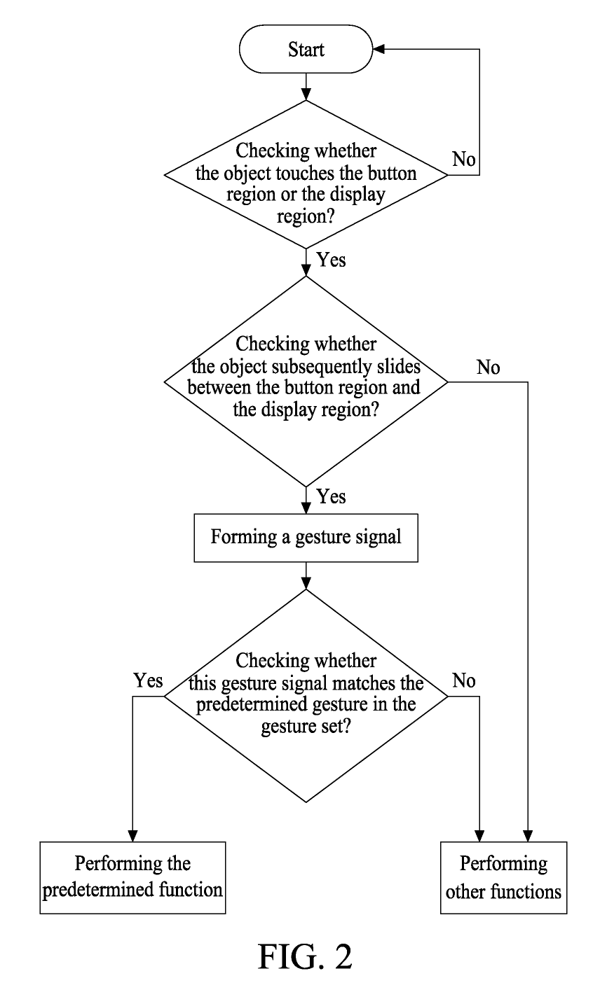

FIG. 1 illustrates the operation of a liquid crystal display apparatus 10 with touch input function according to the first embodiment of the present invention, and FIG. 2 illustrates a flowchart showing a method for recognizing gestures according to the first embodiment of the present invention. Referring to FIG. 1, in one embodiment of the present invention, the liquid crystal display apparatus 10 includes a body 12, an LCD panel 22 with built-in touch input function positioned on the body 12, an external touch panel 24 adhered to the body 12, and a transparent cover 14. The liquid crystal display apparatus 10 can be roughly divided into an image display region 20 and a button region 30 (non-display region). The touch panel 24 is positioned in the button region 30, and a plurality of printed buttons (or pasted buttons) 32 are positioned on the touch panel 24. The buttons 32 in the non-display region 30 may be optionally integrated into the display region 20, i.e., using the LCD panel 22 with built-in touch input function to display the buttons 32.

Referring to FIG. 1 and FIG. 2, in one embodiment of the present invention, the method for recognizing gestures according to the first embodiment checks whether an object 40 such as the finger of the user touches the button region 30 or the display region 20 of the liquid crystal display apparatus 10, and then checks whether the object 40 subsequently slides between the button region 30 and the display region 20 of the liquid crystal display apparatus 10 after touching the liquid crystal display apparatus 10. Subsequently, a gesture signal is formed to trigger a predetermined function if the object 40 slides between the display region 20 and the button region 30, and the method then conducts a comparison step to check whether this gesture signal matches a predetermined gesture in a gesture set with several predetermined gesture and corresponding functions. A predetermined function is performed if the gesture signal matches the predetermined gesture; otherwise, the other function is performed.

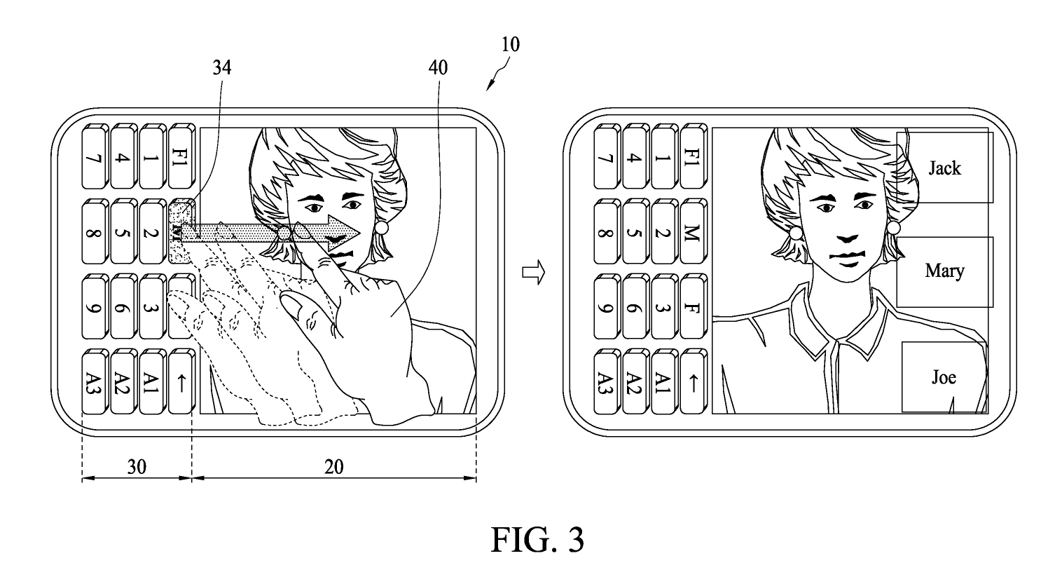

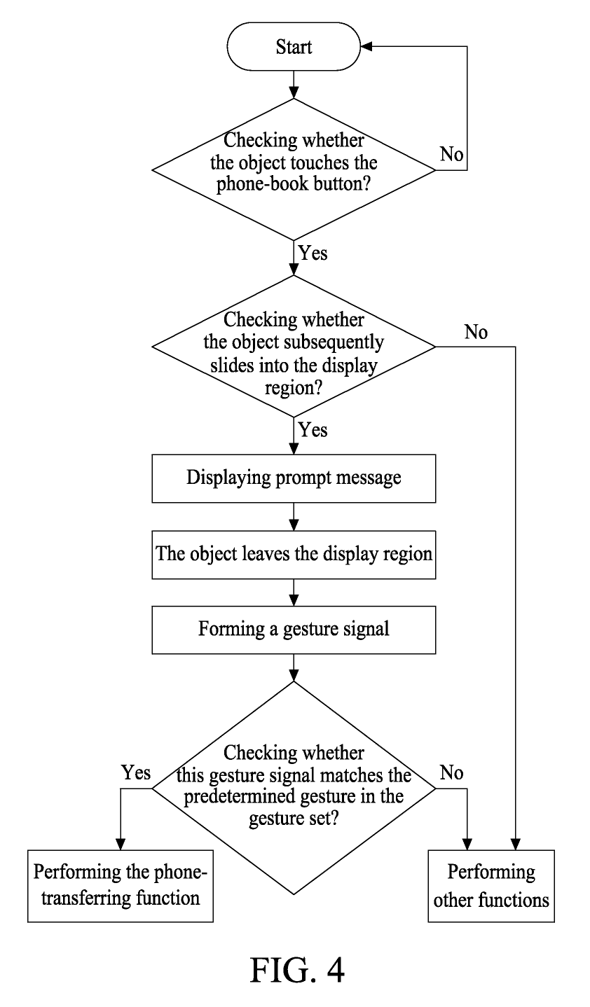

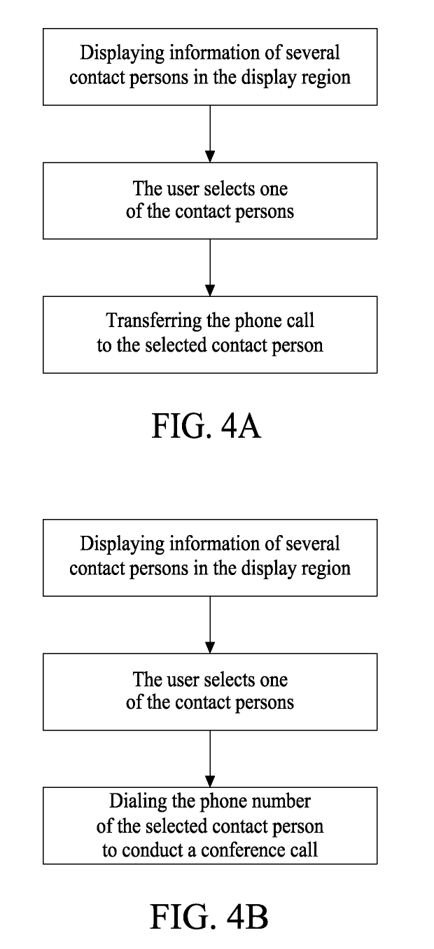

FIG. 3 illustrates the operation of a liquid crystal display apparatus 10 with touch input function according to the second embodiment of the present invention, and FIG. 4 illustrates a flowchart showing a method for recognizing gestures according to the second embodiment of the present invention. Referring to FIG. 3, in one embodiment of the present invention, the button region 30 of the liquid crystal display apparatus 10 includes a function-specified button 34 such as the phone-book button with a predetermined function to perform phone-transferring function. The method for recognizing gestures according to the second embodiment checks whether the object 40 touches the phone-book button 34 in the button region 30, and then checks whether the object 40 subsequently slides into the display region 20 of the liquid crystal display apparatus 10 after touching, i.e., checking whether the object 40 slides with a start point in the button region 30 and checking whether the object 40 slides with an end point in the display region 20; for example, with an end point at the human face in the display region 20.

If the object 40 slides from the button region 30 to the display region 20 of the liquid crystal display apparatus 10, a prompt message is displayed. For example, the display region 20 shows “removing the object will execute phone-transferring function.” When the user confirms the phone-transferring function is the desired function, the object 40 is removed to form a gesture signal. Subsequently, the method conducts a comparison step to check whether this gesture signal matches a predetermined gesture in a gesture set with several predetermined gestures and corresponding functions. The phone-transferring function is performed if the gesture signal matches the predetermined gesture; otherwise, the other function is performed.

Performing the phone-transferring function during a phone call may include displaying information of a plurality of contact persons on the display region 20, wherein the information may include images such as the photos of contact persons, so that the user can select one of the contact persons and the phone call is then transferred to the selected contact person, as shown in FIG. 4A. In addition, performing the phone-transferring function during a phone call may include displaying information of a plurality of contact persons on the display region 20, so that the user can select one of the contact persons and the phone number of the selected contact person is then dialed to conduct a multi-party conference call, as shown in FIG. 4B.

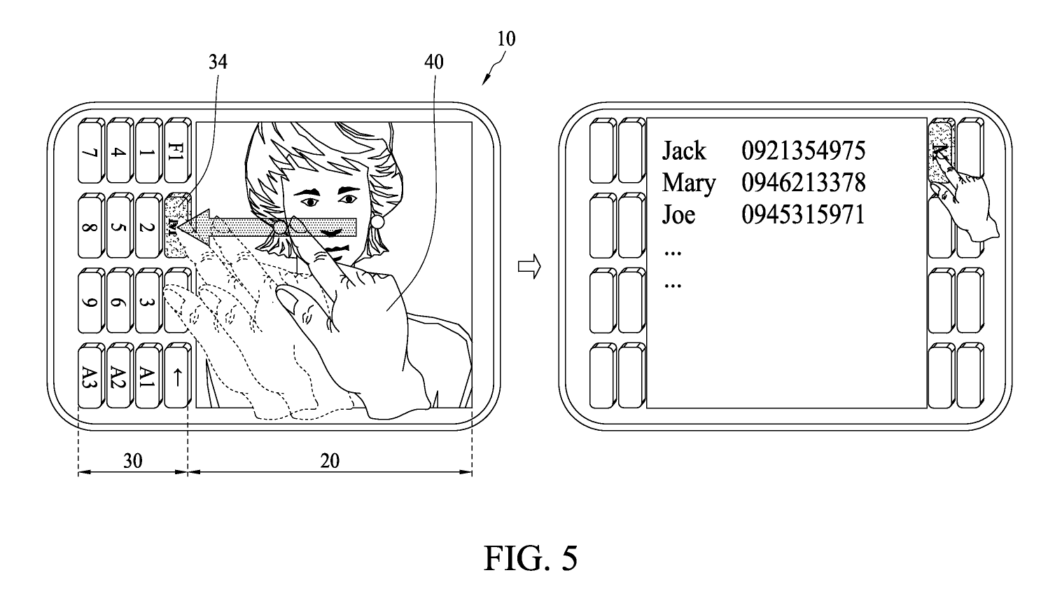

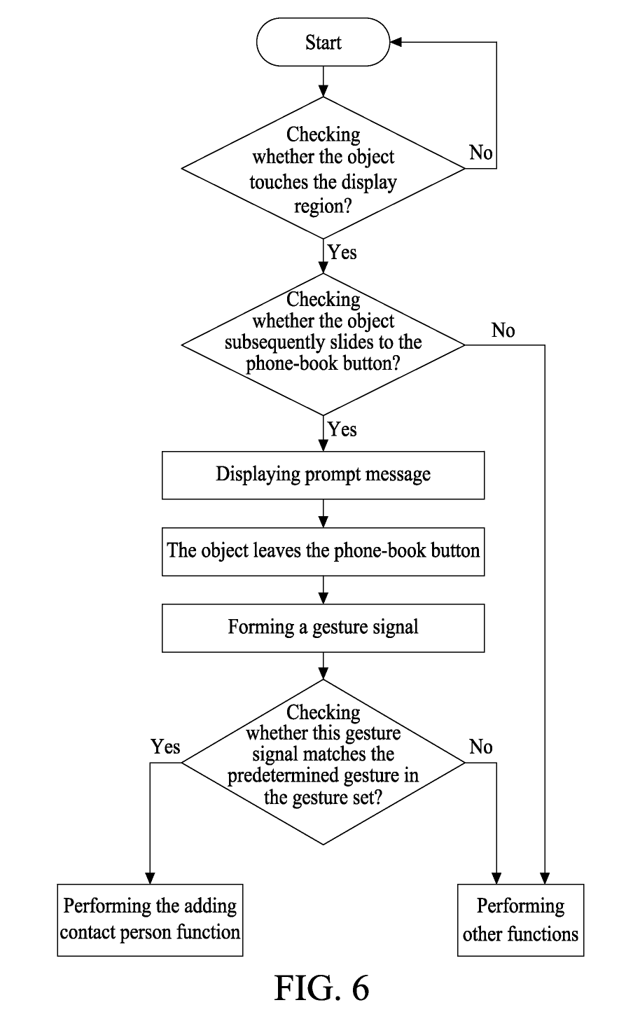

FIG. 5 illustrates the operation of a liquid crystal display apparatus 10 with touch input function according to the third embodiment of the present invention, and FIG. 6 illustrates a flowchart showing a method for recognizing gestures according to the third embodiment of the present invention. Referring to FIG. 5, in one embodiment of the present invention, the button region 30 of the liquid crystal display apparatus 10 includes a phone-book button 34 with a predetermined function to perform adding contact persons. The method for recognizing gestures according to the third embodiment checks whether the object 40 touches the display region 20 showing a portrait, and then checks whether the object 40 subsequently slides to the phone-book button 34 in the button region 30 after touching, i.e., checking whether the object 40 slides with a start point in the display region 20 and an end point in the button region 30.

If the object 40 slides from the display region 20 to the phone-book button 34 in the button region 30, a prompt message is displayed. For example, the display region 20 shows “removing the object will execute adding contact persons function.” When the user confirms the adding contact persons function is the desired function, the object 40 is removed to form a gesture signal. Subsequently, the method conducts a comparison step to check whether this gesture signal matches a predetermined gesture in a gesture set with several predetermined gestures and corresponding functions. The adding contact persons function is performed if the gesture signal matches the predetermined gesture; otherwise, the other function is performed. In particular, executing the adding contact persons function includes displaying an input window in the display region 20 so that the user can input information such as the image, name and phone number of the contact person.

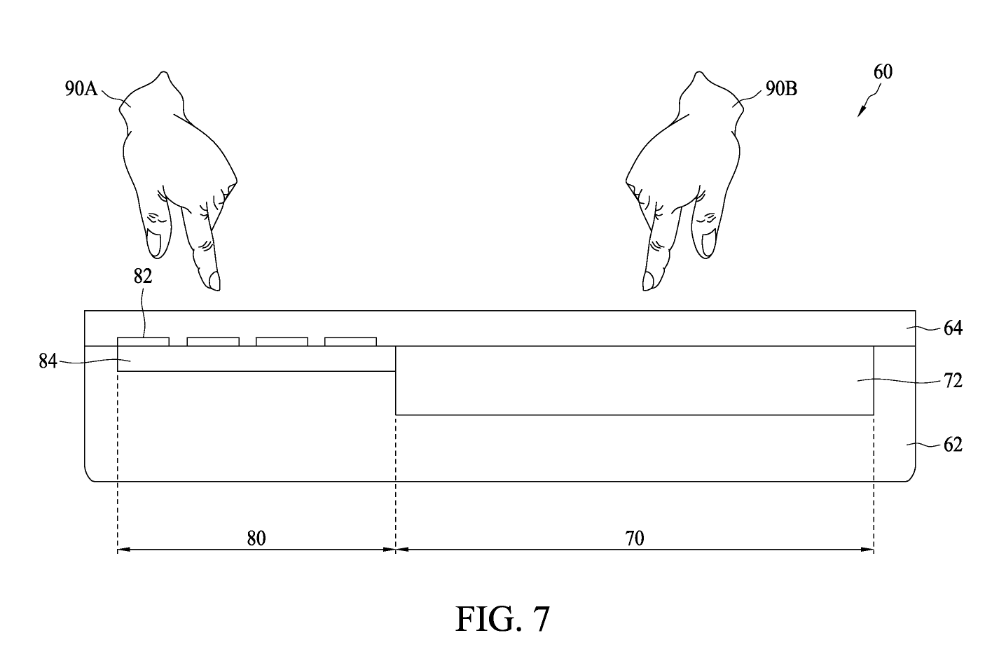

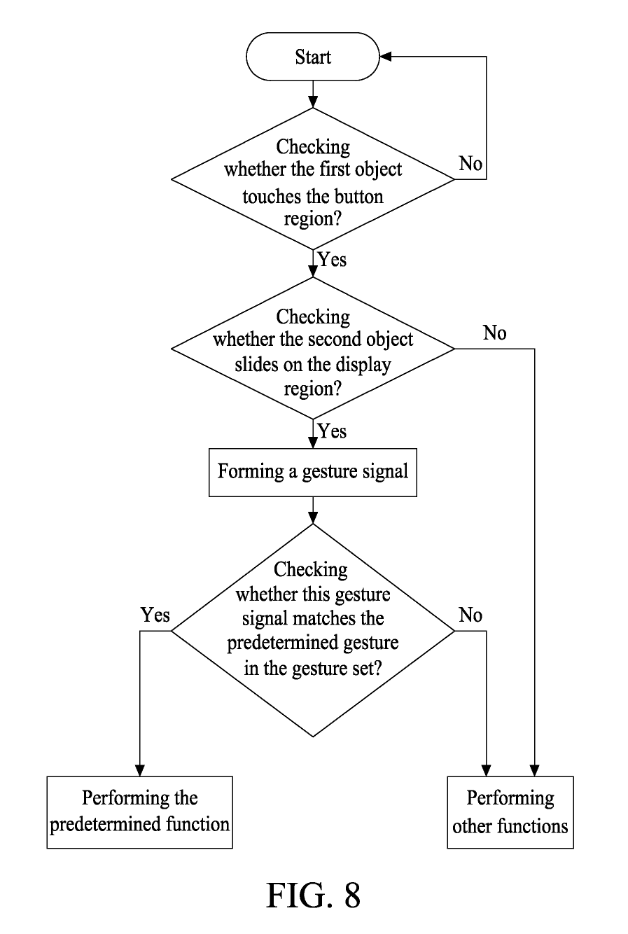

FIG. 7 illustrates the operation of a liquid crystal display apparatus 60 with touch input function according to the fourth embodiment of the present invention, and FIG. 8 illustrates a flowchart showing a method for recognizing gestures according to the fourth embodiment of the present invention. Referring to FIG. 7, in one embodiment of the present invention, the liquid crystal display apparatus 60 includes a body 62, an LCD panel 72 with built-in touch input function positioned on the body 62, an external touch panel 84 adhered to the body 62, and a transparent cover 64. The liquid crystal display apparatus 60 can be roughly divided into an image display region 70 and a button region 80 (non-display region). The touch panel 84 is positioned in the button region 80, and a plurality of printed buttons (or pasted buttons) 82 are positioned on the touch panel 84. The buttons 82 in the non-display region 80 may be optionally integrated into the display region 70, i.e., using the LCD panel 72 with built-in touch input function to display the buttons 82.

Referring to FIG. 7 and FIG. 8, in one embodiment of the present invention, the method for recognizing gestures checks whether a first object 90A touches the button 82 in the button region 80 of the liquid crystal display apparatus 60, and then checks whether a second object 90B slides on the display region 70 of the liquid crystal display apparatus 10. Subsequently, a gesture signal is formed to perform a predetermined function if the second object 90B slides on the display region 70 when the first object 90A touches the button region 80, and the method then conducts a comparison step to check whether this gesture signal matches a predetermined gesture in a gesture set with several predetermined gestures and corresponding functions. A predetermined function is performed if the gesture signal matches the predetermined gesture; otherwise, the other function is performed.

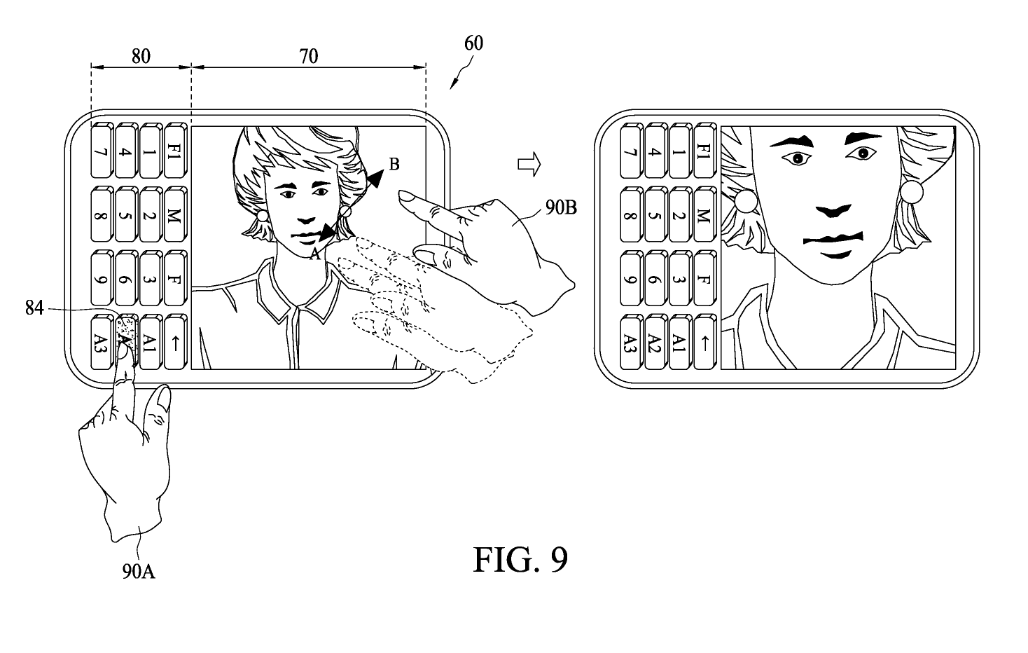

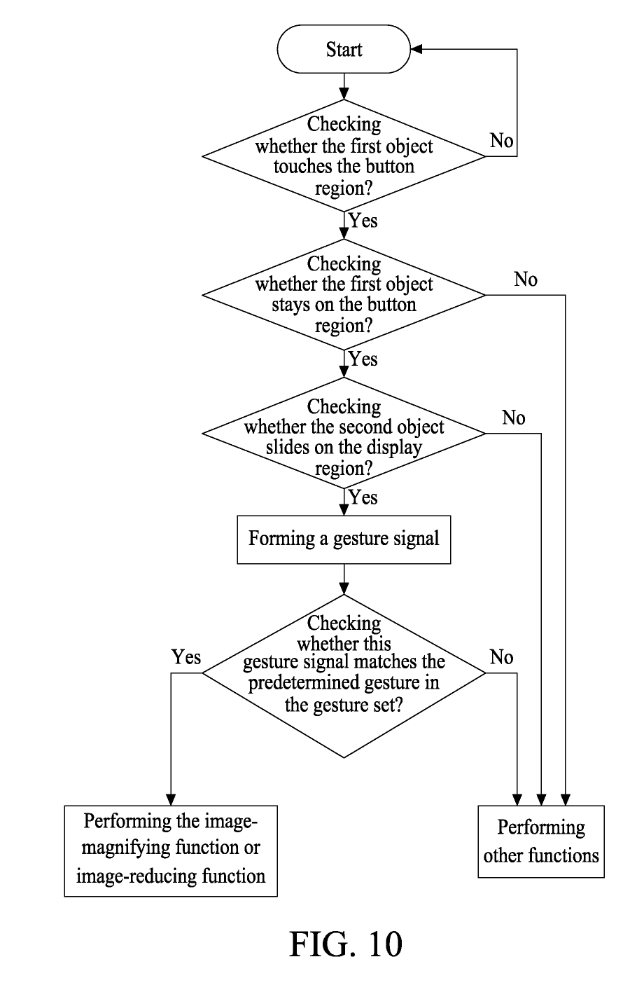

FIG. 9 illustrates the operation of a liquid crystal display apparatus 60 with touch input function according to the fifth embodiment of the present invention, and FIG. 10 illustrates a flowchart showing a method for recognizing gestures according to the fifth embodiment of the present invention. Referring to FIG. 9, in one embodiment of the present invention, the display region 70 displays an image, and the predetermined function is an image-magnifying function or an image-reducing function such as dynamic zooming function. The method for recognizing gestures checks whether the first object 90A touches a predetermined button 84 in the button region 80, checks whether the first object 90A stays on the predetermined button 84 in the button region 80 for a predetermined duration, and then checks whether the second object 90B slides on the display region 70 of the liquid crystal display apparatus 10 such as sliding from point A to point B. For example, the predetermined duration may be 1 to 5 seconds. Subsequently, a gesture signal is formed to perform a predetermined function if the second object 90B slides from point A to point B on the display region 70 when the first object 90A touches the button 84 in the button region 80, and the method then conducts a comparison step to check whether this gesture signal matches a predetermined gesture in a gesture set with several predetermined gestures and corresponding functions. The image-magnifying function or image-reducing function is performed if the gesture signal matches the predetermined gesture; otherwise, the other function is performed. Performing the image-magnifying function or image-reducing function may take the sliding distance or sliding speed of the second object 90B into consideration to dynamically zoom the image. For example, the image is magnified if the second object 90B slides along a first direction from point A to point B, and the image is reduced if the second object 90B slides along a second direction from point B to point A.

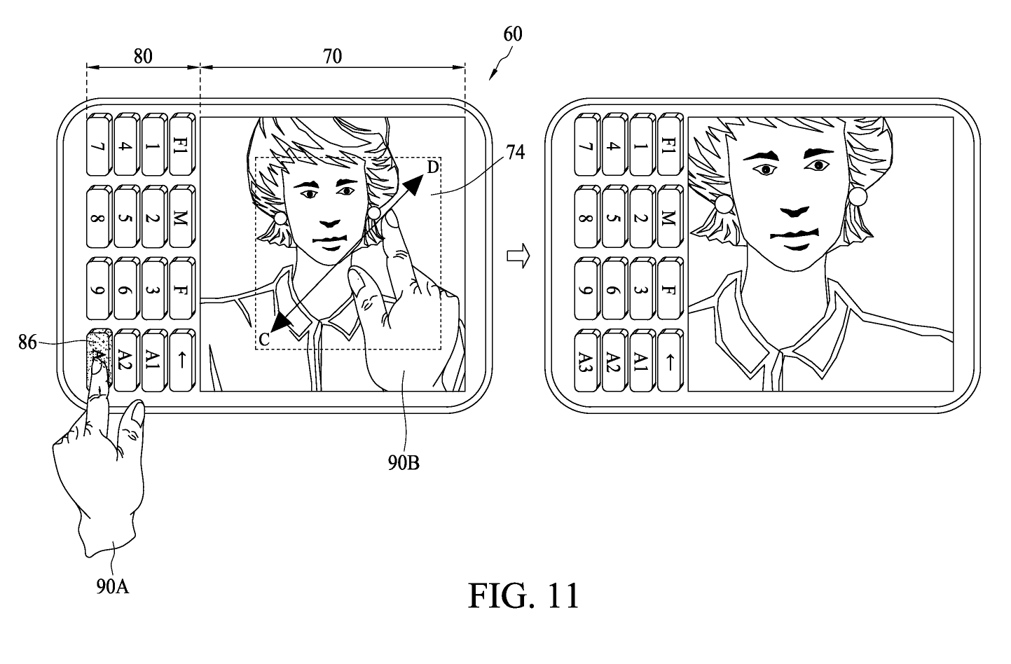

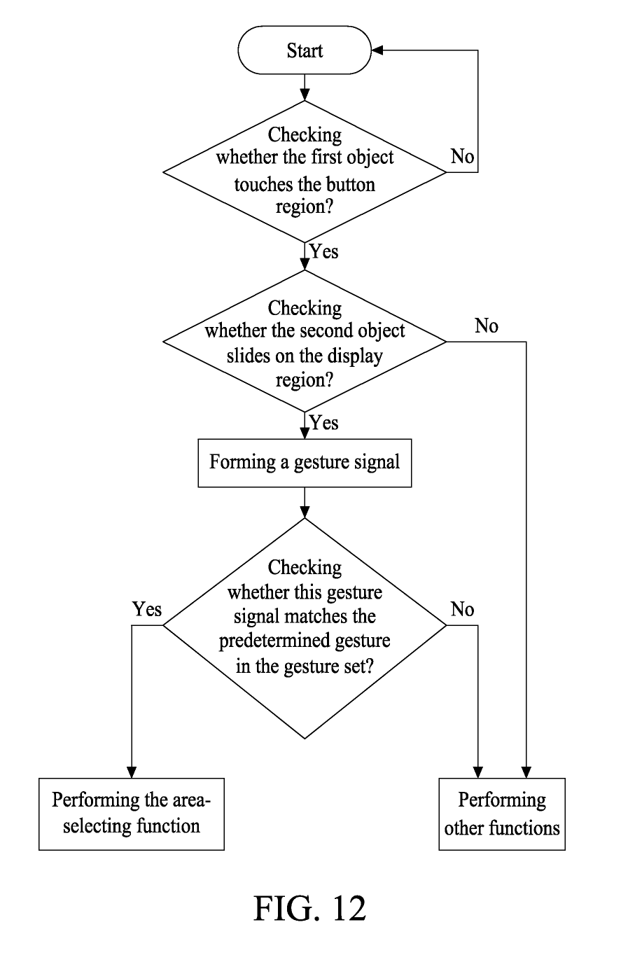

FIG. 11 illustrates the operation of a liquid crystal display apparatus 60 with touch input function according to the sixth embodiment of the present invention, and FIG. 12 illustrates a flowchart showing a method for recognizing gestures according to the sixth embodiment of the present invention. In one embodiment of the present invention, the display region 70 displays an image, and the predetermined function is an area-selecting function. The method for recognizing gestures checks whether the first object 90A touches a predetermined button 86 in the button region 80, and then checks whether the second object 90B slides on the display region 70 of the liquid crystal display apparatus 10. For example, two fingers slide from the center to the corner of the displayer region 70, respectively. The thumb serving as one of the second object 90B slides from the center to point C, while the forefinger serving as another second object 90B slides from the center to point D, as shown in FIG. 11.

Subsequently, a gesture signal is formed to trigger a predetermined function if the second object 90B slides on the display region 80 (the thumb sliding to the point C and the forefinger sliding to the point D) when the first object 90A touches the button 86 in the button region 80, and the method then conducts a comparison step to check whether this gesture signal matches a predetermined gesture in a gesture set with several predetermined gestures and corresponding functions. The area-selecting function is performed if the gesture signal matches the predetermined gesture; otherwise, the other function is performed. Performing the area-selecting function may take the sliding distance of the second object 90B into consideration to select a predetermined area 74 of the display region 70, and the image of the predetermined area 74 is then magnified or reduced. For example, the image is magnified if the two fingers serving as the second objects 90B slide outwardly, i.e., toward a periphery of the display region 70. The image is reduced if the two fingers serving as the second objects 90B slides inwardly, i.e., toward the center of the display region 70.

In conclusion, the embodiments of the present method for recognizing gestures on a liquid crystal display apparatus with touch input function incorporates touch and slide actions to form new input functions, without modifying the hardware design to dramatically improve the product development flexibility.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for recognizing gestures on a liquid crystal display apparatus with touch input function, the liquid crystal display apparatus including a display region and a button region, the method comprising the steps of:
checking whether an object touches the liquid crystal display apparatus;
checking whether the object slides on the liquid crystal display apparatus after touching the liquid crystal display apparatus; and
forming a gesture signal to perform a predetermined function if the object slides between the display region and the button region.

2. The method for recognizing gestures on a liquid crystal display apparatus with touch input function of claim 1, wherein the checking of whether the object slides on the liquid crystal display apparatus includes:
checking whether the object slides with a start point in the button region; and
checking whether the object slides with an end point in the display region.

3. The method for recognizing gestures on a liquid crystal display apparatus with touch input function of claim 2, wherein the checking of whether an object touches the liquid crystal display apparatus is checking whether the object touches the button region.

4. The method for recognizing gestures on a liquid crystal display apparatus with touch input function of claim 2, wherein the predetermined function is a phone-transferring function.

5. The method for recognizing gestures on a liquid crystal display apparatus with touch input function of claim 2, wherein performing the predetermined function includes displaying information of a plurality of contact persons on the display region.

6. The method for recognizing gestures on a liquid crystal display apparatus with touch input function of claim 1, wherein the checking of whether the object slides on the liquid crystal display apparatus includes:
checking whether the object slides with a start point in the display region; and
checking whether the object slides with an end point on a predetermined button in the button region.

7. The method for recognizing gestures on a liquid crystal display apparatus with touch input function of claim 6, wherein the checking of whether an object touches the liquid crystal display apparatus is checking whether the object touches the display region.

8. The method for recognizing gestures on a liquid crystal display apparatus with touch input function of claim 6, wherein the display region displays a portrait before the object touches the liquid crystal display apparatus, and the predetermined function is an adding contact person function.

9. The method for recognizing gestures on a liquid crystal display apparatus with touch input function of claim 8, wherein performing the predetermined function includes displaying the image, a name and a phone number thereof.

10. A method for recognizing gestures on a liquid crystal display apparatus with touch input function, the liquid crystal display apparatus including a display region and a button region, the method comprising the steps of:
checking whether a first object touches the button region;
checking whether a second object slides on the display region; and
forming a gesture signal to perform a predetermined function if the second object slides on the display region when the first object touches the button region.

11. The method for recognizing gestures on a liquid crystal display apparatus with touch input function of claim 10, further comprising a step of checking the gesture signal matches a predetermined gesture in a gesture set.

12. The method for recognizing gestures on a liquid crystal display apparatus with touch input function of claim 10, wherein the predetermined function is an image-magnifying function or an image-reducing function.

13. The method for recognizing gestures on a liquid crystal display apparatus with touch input function of claim 12, wherein performing the predetermined function includes magnifying or reducing an image by taking a sliding distance or a sliding speed of the second object into consideration.

14. The method for recognizing gestures on a liquid crystal display apparatus with touch input function of claim 12, wherein performing the predetermined function includes magnifying an image if the second object slides along a predetermined direction.

15. The method for recognizing gestures on a liquid crystal display apparatus with touch input function of claim 12, wherein performing the predetermined function includes reducing an image if the second object slides along a predetermined direction.

16. The method for recognizing gestures on a liquid crystal display apparatus with touch input function of claim 10, wherein the predetermined function is an area-selecting function.

17. The method for recognizing gestures on a liquid crystal display apparatus with touch input function of claim 16, wherein performing the predetermined function includes selecting a predetermined area of the display region by taking a sliding distance of the second object into consideration.

18. The method for recognizing gestures on a liquid crystal display apparatus with touch input function of claim 17, wherein performing the predetermined function includes magnifying or reducing an image of the predetermined area.

19. The method for recognizing gestures on a liquid crystal display apparatus with touch input function of claim 18, wherein performing the predetermined function includes magnifying the image of the predetermined area if the second object slides toward a periphery of the display region.

20. The method for recognizing gestures on a liquid crystal display apparatus with touch input function of claim 18, wherein performing the predetermined function includes reducing the image of the predetermined area if the second object slides toward a center of the display region.
